(19) United States
(12) Patent Application Publication
(10) Pub. No.: US 2013/0050536 A1
(43) Pub. Date: Feb. 28, 2013

(54) COMPOUND-EYE IMAGING DEVICE

(71) Applicants: Yuichi SUZUKI, Osaka (JP); Taizo Aoki, Hyogo (JP)

(72) Inventors: Yuichi SUZUKI, Osaka (JP); Taizo Aoki, Hyogo (JP)

(73) Assignee: Panasonic Corporation, Osaka (JP)

(21) Appl. No.: 13/584,826

(22) Filed: Aug. 14, 2012

(30) Foreign Application Priority Data
Aug. 25, 2011 (JP) 2011-183893

(51) Int. Cl. H04N 5/262

(52) U.S. Cl. 348/240.3; 348/E05.051

(57) ABSTRACT

A compound-eye imaging device includes a first optical system that has a first zoom lens, a second optical system that has a second zoom lens, a first imaging sensor, a second imaging sensor, a zoom manipulation component, an interface, and a zoom controller. The first imaging sensor captures a subject image formed by the first optical system and outputs data. The second imaging sensor captures a subject image formed by the second optical system and outputs data. The zoom manipulation component is configured to be manipulated to drive either the first or the second zoom lens. The interface is configured to receive a particular input to select either the first or the second zoom lens as an active zoom lens. The particular input dictates manipulation of the zoom manipulation component. The zoom controller is configured to drive the active zoom lens according to how the zoom manipulation component is manipulated.

### CROSS-REFERENCE TO RELATED APPLICATIONS

This application claims priority under 35 U.S.C. §119 to Japanese Patent Application No. 2011-183893, filed on Aug. 25, 2011. The entire disclosure of Japanese Patent Application No. 2011-183893 is hereby incorporated herein by reference.

### BACKGROUND

1. Technical Field

The technology disclosed herein relates to a compound-eye imaging device equipped with two or more optical systems.

2. Background Information

Japanese Laid-Open Patent Application 2011-45039 discloses a method in which, in a digital camera comprising a first imaging element and a second imaging element, a first zoom lens corresponding to a first imaging element is fixed at the telephoto end, and only a second zoom lens corresponding to a second imaging element is capable of being manipulated or undergoing zoom manipulation.

### SUMMARY

However, with the method discussed in Japanese Laid-Open Patent Application 2011-45039, the first zoom lens cannot be manipulated for zoom.

Therefore, this method cannot accommodate a user need in which the user wants to change the field angle freely between the first and second imaging sensors.

In view of this, one possibility is to allow the first and second zoom lenses each to be manipulated for zoom, but it is preferable to provide just one zoom manipulation component for handling zoom manipulation, in order to reduce the size and weight of a digital camera.

However, if there is only one zoom manipulation component, a problem is that the digital camera cannot determine whether the zoom manipulation is intended for the first or second zoom lens.

The technology disclosed herein was conceived in light of the above problem, and one object thereof is to provide a compound-eye imaging device capable of determining whether zoom manipulation is for a first or second zoom lens.

Accordingly, a compound-eye imaging device is provided that includes a first optical system, a second optical system, a first imaging sensor, a second imaging sensor, a zoom manipulation component, an interface, and a zoom controller. The first optical system has a first zoom lens. The second optical system has a second zoom lens. The first imaging sensor is configured to capture a subject image formed by the first optical system and outputs first image data. The second imaging sensor is configured to capture a subject image formed by the second optical system and outputs second image data. The zoom manipulation component is configured to be manipulated to drive either the first zoom lens or the second zoom lens. The interface is configured to receive a particular input to select either the first zoom lens or the second zoom lens as an active zoom lens. The particular input dictates manipulation of the zoom manipulation component. The zoom controller is configured to drive the active zoom lens according to how the zoom manipulation component is manipulated.

These and other features, aspects and advantages of the technology disclosed herein will become apparent to those skilled in the art from the following detailed description, which, taken in conjunction with the annexed drawings, discloses example embodiments of the present invention.

### BRIEF DESCRIPTION OF THE DRAWINGS

Referring now to the attached drawings which form a part of this original disclosure:

FIG. 1 is a block diagram of the electrical configuration of a digital camera;

FIG. 2 is a block diagram of the electrical configuration of a controller;

FIG. 3 is a simplified diagram of an example of an image displayed on a liquid crystal display;

FIG. 4 is a simplified diagram of an example of an image displayed on a liquid crystal display; and

FIG. 5 is a flowchart illustrating the imaging operation of a digital camera.

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents. Accordingly, a digital camera will now be described through reference to the drawings.

1-1. Configuration of Digital Camera

First, the configuration of a digital camera will be described.

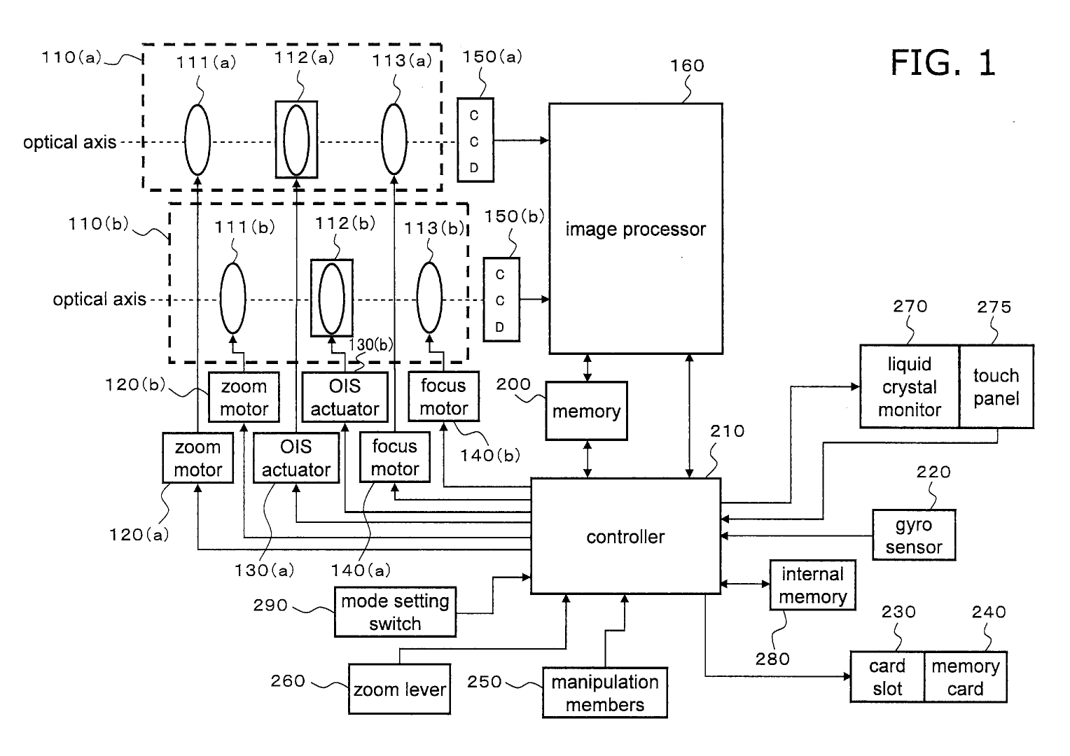

FIG. 1 is a block diagram of the electrical configuration of a digital camera in this embodiment.

The electrical configuration of the digital camera 1 pertaining to this embodiment will be described through reference to FIG. 1. The digital camera 1 comprises optical systems 110(a) and 110(b), zoom motors 120(a) and 120(b), OIS actuators 130(a) and 130(b), focus motors 140(a) and 140(b), CCD image sensors 150(a) and 150(b), an image processor 160, a memory 200, a controller 210, a gyro sensor 220, a card slot 230, a memory card 240, manipulation members 250, a zoom lever 260, a liquid crystal display 270 (one example of a “display device”), an internal memory 280, and a mode setting switch 290.

The optical system 110(a) includes a zoom lens 111(a), an OIS 112(a), and a focus lens 113(a). The optical system 110(b) includes a zoom lens 111(b), an OIS 112(b), and a focus lens 113(b). The optical system 110(a) forms a subject image at a first viewpoint. The optical system 110(b) forms a subject image at a second viewpoint that is different from the first viewpoint. In this embodiment, the first viewpoint corresponds to the left eye of the user, and the second viewpoint corresponds to the right eye of the user. The optical system 110(a) is an example of a “first optical system,” and the optical system 110(b) is an example of a “second optical system.”

The zoom lenses 111(a) and 111(b) move along the optical axes of the optical systems 110(a) and 110(b), respectively, and are thereby able to enlarge or reduce the subject images formed by the CCD image sensors 150(a) and 150(b). The drive of the zoom lenses 111(a) and 111(b) is driven by the zoom motors 120(a) and 120(b), respectively. The zoom lens 111(a) is an example of a “first zoom lens,” and the zoom lens 111(b) is an example of a “second zoom lens.”

The OIS's 112(a) and 112(b) each have an internal correcting lens that can move in a plane that is perpendicular to the optical axis. The OIS's 112(a) and 112(b) reduce blurring of the subject image by driving the correcting lenses in directions that cancel out shaking of the digital camera 1. The drive of the OIS's 112(a) and 112(b) is driven by the OIS actuators 130(a) and 130(b), respectively.

The focus lenses 113(a) and 113(b) move along the optical axes of the optical systems 110(a) and 110(b), respectively, and are thereby able to adjust the focus of the subject images formed by the CCD image sensors 150(a) and 150(b). The focus lenses 113(a) and 113(b) are controlled by the focus motors 140(a) and 140(b), respectively. The focus lens 113(a) is an example of a “first focus lens,” and the focus lens 113(b) is an example of a “second focus lens.”

In the following description, the optical systems 110(a) and 110(b) will sometimes be collectively referred to simply as the optical systems 110. The same applies to the zoom lenses 111, the OIS's 112, the focus lenses 113, the zoom motors 120, the OIS actuators 130, the focus motors 140, and the CCD image sensors 150.

The zoom motors 120(a) and 120(b) drive the zoom lenses 111(a) and 111(b), respectively. The zoom motors 120(a) and 120(b) may be pulse motors, DC motors, linear motors, servo motors, or the like. The zoom motors 120(a) and 120(b) may also drive the zoom lenses 111(a) and 111(b) via a cam mechanism, a ball screw, or another such mechanism. They may also be configured to control the zoom lenses 111(a) and 111(b) with the same operation.

The OIS actuators 130(a) and 130(b) drive the correcting lenses in the OIS's 112(a) and 112(b), respectively, within a plane that is perpendicular to the optical axis. The OIS actuators 130(a) and 130(b) can be planar coils, ultrasonic motors, or the like.

The focus motors 140(a) and 140(b) drive the focus lenses 113(a) and 113(b), respectively. The focus motors 140(a) and 140(b) may be pulse motors, DC motors, linear motors, servo motors, or the like. The focus motors 140(a) and 140(b) may also drive the focus lenses 113(a) and 113(b), respectively, via a cam mechanism, a ball screw, or another such mechanism.

The CCD image sensors 150(a) and 150(b) capture subject images formed by the optical systems 110(a) and 110(b), respectively, and produce first image data and second image data. The CCD image sensors 150(a) and 150(b) are spaced apart by a specific gap (such as about 3 cm) in the left and right direction. In this embodiment, the first image data is a signal indicating a left-eye image, and the second image data is a signal indicating a right-eye image.

The CCD image sensors 150(a) and 150(b) perform various operations, such as exposure, transfer, and electronic shuttering. The CCD image sensor 150(a) is an example of a “first imaging sensor,” and the CCD image sensor 150(b) is an example of a “second imaging sensor.”

The image processor 160 subjects the first image data and second image data produced by the CCD image sensors 150(a) and 150(b) to various kinds of processing (such as gamma correction, white balance correction, and scratch correction). Consequently, the image processor 160 produces image data for display on the liquid crystal display 270, or produces image data to be stored on the memory card 240. For example, the image processor 160 starts the production of still picture image data on the basis of first image data when the still picture release button (discussed below) has been pressed to capture a still picture. Also, the image processor 160 subjects the first image data and second image data to edge enhancement processing or other such enhancement processing on the basis of a control signal from the controller 210.

The image processor 160 also subjects the first image data and second image data that have undergone the above processing to compression processing in a compression format that conforms to the JPEG standard, for example. The two sets of compressed image data obtained by compressing the first image data and second image data are associated with each other and recorded to the memory card 240. In the recording of the two sets of compressed image data, the recording is preferably performed using an MPO file format. When the image data being compressed is a moving picture, an H.264/MPEG-4 AVC or other such moving picture compression standard will be applied. The configuration may also be such that an MPO file format and a JPEG image or MPEG moving picture are recorded simultaneously.

The image processor 160 can be a DSP, a microprocessor, or the like. The resolution (pixel count) of the through image made be set to the screen resolution of the liquid crystal display 270, or may be set to the resolution of the image data compressed and formed in a compression format that conforms to the JPEG standard.

The memory 200 functions as a working memory for the image processor 160 and the controller 210. For example, the memory 200 temporarily stores image data processed by the image processor 160, or image data inputted from the CCD image sensors 150 prior to being processed by the image processor 160. The memory 200 also temporarily stores imaging conditions for the optical systems 110 and the CCD image sensors 150 during imaging. “Imaging conditions” here refers to the subject distance, field angle information, ISO sensitivity, the shutter speed, the EV value, the F value, the distance between lenses, the imaging date and time, the OIS shift amount, and so forth. The memory 200 can be a DRAM, a ferroelectric memory, or the like.

The controller 210 is a control means for controlling everything. In particular, the controller 210 executes drive control of the zoom motors 120 and the focus motors 140, display control of the liquid crystal display 270, and so forth. The controller 210 may be constituted by hardware alone, or by a combination of hardware and software. The controller 210 can be a microprocessor or the like. The configuration and function of the controller 210 will be discussed below.

The gyro sensor 220 is constituted by a piezoelectric element or another such vibrating member. The gyro sensor 220 obtains angular velocity information by vibrating the piezoelectric element or other such vibrating member at a specific frequency, and converting the resulting Coriolis force into voltage. Any hand shake imparted to the digital camera 1 by the user is corrected by driving the correcting lenses inside the OIS's 112 in the direction of canceling out the shake indicated by the angular velocity information obtained from the gyro sensor 220. The gyro sensor 220 may be any device that is capable of at least measuring angular velocity information for a pitch angle. If the gyro sensor 220 is also capable of measuring angular velocity information for a yaw angle, then rotation when the digital camera 1 is moved substantially in the horizontal direction can be taken into account.

The card slot 230 allows the memory card 240 to be inserted. The card slot 230 can be mechanically and electrically connected to the memory card 240.

The memory card 240 includes an internal flash memory, ferroelectric memory, etc., and is able to store data.

“Manipulation members 250” is the collective name of a user interface that is manipulated by the user. For example, it may comprise a cross key, an enter button, a moving picture release button, and a still picture release button that are manipulated by the user. The moving picture release button is pressed to capture a moving picture corresponding to the first image data and/or second image data. The still picture release button is pressed to capture a still picture corresponding to the first image data and/or second image data and to perform AF control of a subject at the CCD image sensors 150 (hereinafter referred to as AF control). More specifically, when the still picture release button is pressed half-way down, AF control and AE control are executed via the controller 210. When the release button is pressed all the way down, an image of the subject is captured.

The zoom lever 260 is manipulated by the user to drive either the zoom lens 111(a) or the zoom lens 111(b) (hereinafter referred to as “zooming”). The user uses the zoom lever 260 to drive the zoom lens 111(a) or the zoom lens 111(b) and thereby form a subject image at the desired field angle at the CCD image sensors 150(a) and 150(b). The zoom lever 260 is an example of a “zoom manipulation component.”

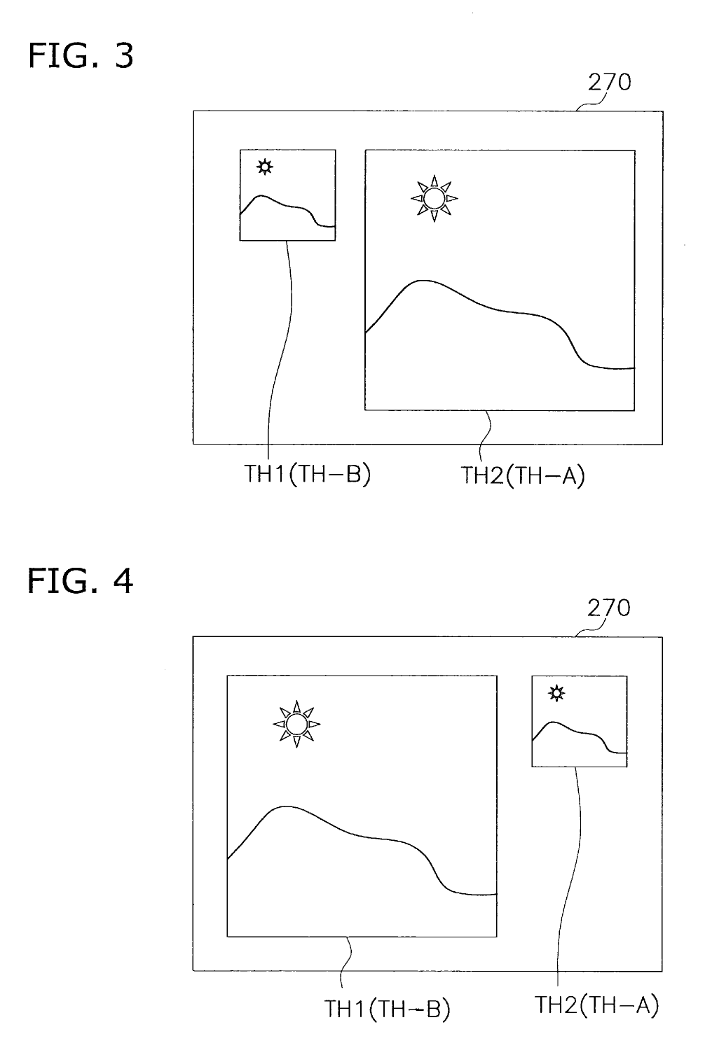

The liquid crystal display 270 displays a first through image TH1 corresponding to first image data and a second through image TH2 corresponding to second image data produced by the CCD image sensors 150, side by side (see FIGS. 3 and 4). Also, the liquid crystal display 270 is able to display the first through image TH1 and the second through image TH2 in mutually different sizes. More specifically, the liquid crystal display 270 displays either the first through image TH1 or the second through image 1142, depending on which through image corresponds to zoom manipulation of the zoom lever 260 (hereinafter referred to as the “active through image TH-A”), larger than the through image that does not correspond to zoom manipulation of the zoom lever 260 (hereinafter referred to as the “inactive through image TH-B”). This allows the user to find out whether the zoom lens 111(a) or the zoom lens 111(b) is being driven by zoom manipulation of the zoom lever 260.

A “through image” here is a moving picture that appears on the liquid crystal display 270 by the successive display of images. This through image is used by the user to decide on the composition of the subject, and the through image itself is usually not stored in the memory card 240.

A touch panel 275 is disposed on the liquid crystal display 270 and receives touch operation from the user. More specifically, the touch panel 275 receives manipulation for selecting either the zoom lens 111(a) or the zoom lens 111(b) as the zoom lens that is the object of the zoom manipulation with the zoom lever 260 (hereinafter referred to as the “active zoom lens”), according to touch operation on the inactive through image TH-B (hereinafter referred to as “selection manipulation”). Also, the touch panel 275 receives manipulation for specifying the focus lens corresponding to the active through image TH-A from among the focus lens 113(a) and the focus lens 113(b), according to the touch operation on the active through image TH-A (hereinafter referred to as “specification manipulation”). When touch operation is received, the touch panel 275 sends the controller 210 position data indicating the touch position on the liquid crystal display 270. The touch panel 275 is one example of an “interface.”

The internal memory 280 is constituted by a flash memory, a ferroelectric memory, or the like. The internal memory 280 stores control programs and so forth for controlling the entire digital camera 1.

The mode setting switch 290 is used to switch between wide angle/telephoto simultaneous imaging mode when capturing 2D images with the digital camera 1, 3D imaging mode when capturing 3D images with the digital camera 1, and reproduction mode when reproducing captured images. In wide angle/telephoto simultaneous imaging mode, still pictures corresponding to the first through image TH1 and the second through image TH2 with different field angles can be captured at the same time. In 3D imaging mode, the first through image TH1 and the second through image TH2 can be simultaneously captured either as moving pictures or still pictures. With the digital camera 1, the proper imaging parameters for a given mode are set every time the user switches between wide angle/telephoto simultaneous imaging mode and 3D imaging mode. In this embodiment, the description will center on the wide angle/telephoto simultaneous imaging mode.

1-2. Configuration of Controller 210

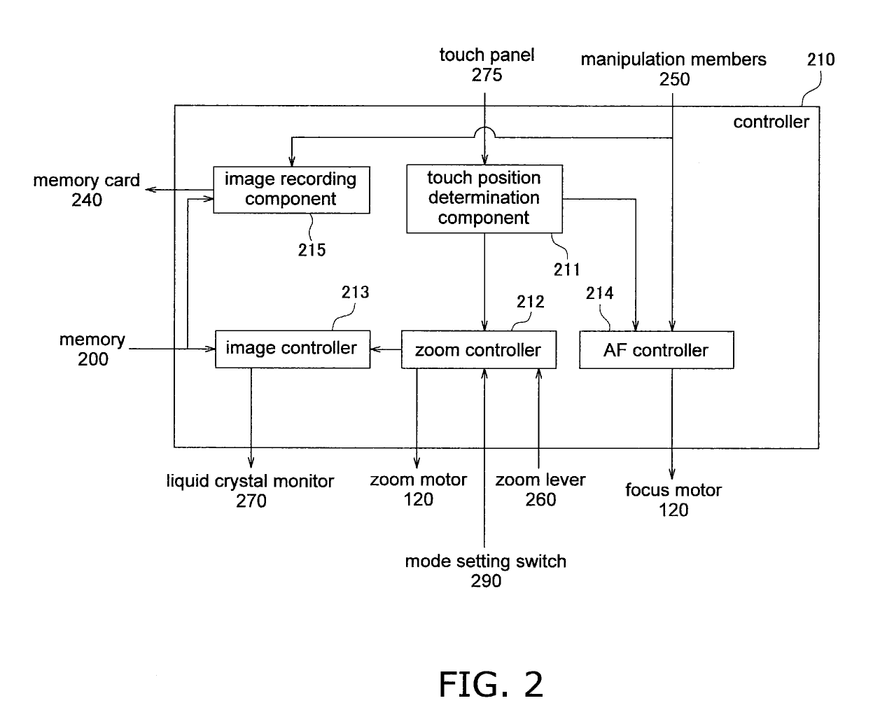

FIG. 2 is a block diagram of the electrical configuration of the controller 210. The controller 210 comprises a touch position determination component 211, a zoom controller 212, a display controller 213, an AF controller 214, and an image recording component 215.

The touch position determination component 211 determines whether the touch position is on the active through image TH-A or on the inactive through image TH-B, on the basis of position data received from the touch panel 275. If the touch position is on the inactive through image TH-B, the touch position determination component 211 notifies the zoom controller 212 and the display controller 213 to this effect. If the touch position is on the active through image TH-A, the touch position determination component 211 notifies the AF controller 214 to this effect.

The zoom controller 212 sets either the zoom lens 111(a) or the zoom lens 111(b) to be the active zoom lens. The zoom controller 212 also drives the active zoom lens set to be the object of zoom manipulation, according to the zoom manipulation.

More specifically, the zoom controller 212 sets either the zoom lens 111(a) or the zoom lens 111(b) to be the active zoom lens when the mode setting switch 290 is switched to the wide angle/telephoto simultaneous imaging mode. This initialization processing may be fixed to either the zoom lens 111(a) or the zoom lens 111(b), or may return to the state at the end of the previous wide angle/telephoto simultaneous imaging mode.

Also, if the zoom controller 212 has been notified by the touch position determination component 211 that the touch position is on the inactive through image TH-B, it sets the active zoom lens to be either the zoom lens 111(a) or the zoom lens 111(b), depending on which one corresponds to the inactive through image TH-B. This change in the setting of the active zoom lens is repeated every time the touch panel 275 is touched on the inactive through image TH-B.

Also, when the zoom lever 260 has received zoom manipulation, the zoom controller 212 drives either the zoom motor 120(a) or 120(b), and thereby controls the drive of the active zoom lens according to zoom manipulation.

When the zoom controller 212 has set the active zoom lens, the display controller 213 sets either the first through image TH1 or the second through image TH2 to be the active through image TH-A, according to which through image corresponds to the active zoom lens. Also, the display controller 213 sets either the first through image TH1 or the second through image TH2 to be the inactive through image TH-B, according to which through image is not the active through image TH-A.

Also, the display controller 213 displays the first through image TH1 and the second through image TH2 on the liquid crystal display 270 on the basis of the first image data and second image data acquired from the memory 200. The display controller 213 here displays the active through image TH-A larger than the inactive through image TH-B. FIG. 3 shows the situation when the first through image TH1 has been set to be the active through image TH-A. FIG. 4 shows the situation when the second through image TH2 has been set to be the active through image TH-A in response to the first through image TH1 being touched.

The AF controller 214 focuses on the touch position on the active through image TH-A upon receipt of notification from the touch position determination component 211 to the effect that the touch position is on the active through image TH-A. More specifically, the AF controller 214 drives either the focus lens 113(a) or 113(b), depending on which focus lens corresponds to the active through image TH-A, and thereby executes focus adjustment of the subject image formed by either the CCD image sensor 150(a) or 150(b), depending on which CCD image sensor corresponds to the active through image TH-A.

Also, if the still picture release button (one of the manipulation members 250) has been pressed half-way down, the AF controller 214 drives the focus lenses 113(a) and 113(b) and thereby executes focus adjustment of the subject images formed by the CCD image sensors 150(a) and 150(b).

The AF controller 214 also executes AF control according to a known procedure as described below. First, the AF controller 214 changes the position of the focus lenses 113 by controlling the focus motors 140, after which it acquires an image processing result for contrast AF by the image processor 160. Then, the AF controller 214 repeatedly controls the focus motors 140 until the proper image processing result is obtained, that is, until AF control is completed.

The image recording component 215 reads image data from the memory 200 in response to manipulation received at the manipulation members 250, and records a moving picture or still picture corresponding to the first image data and second image data to the memory card 240.

1-3. Imaging Operation of Digital Camera

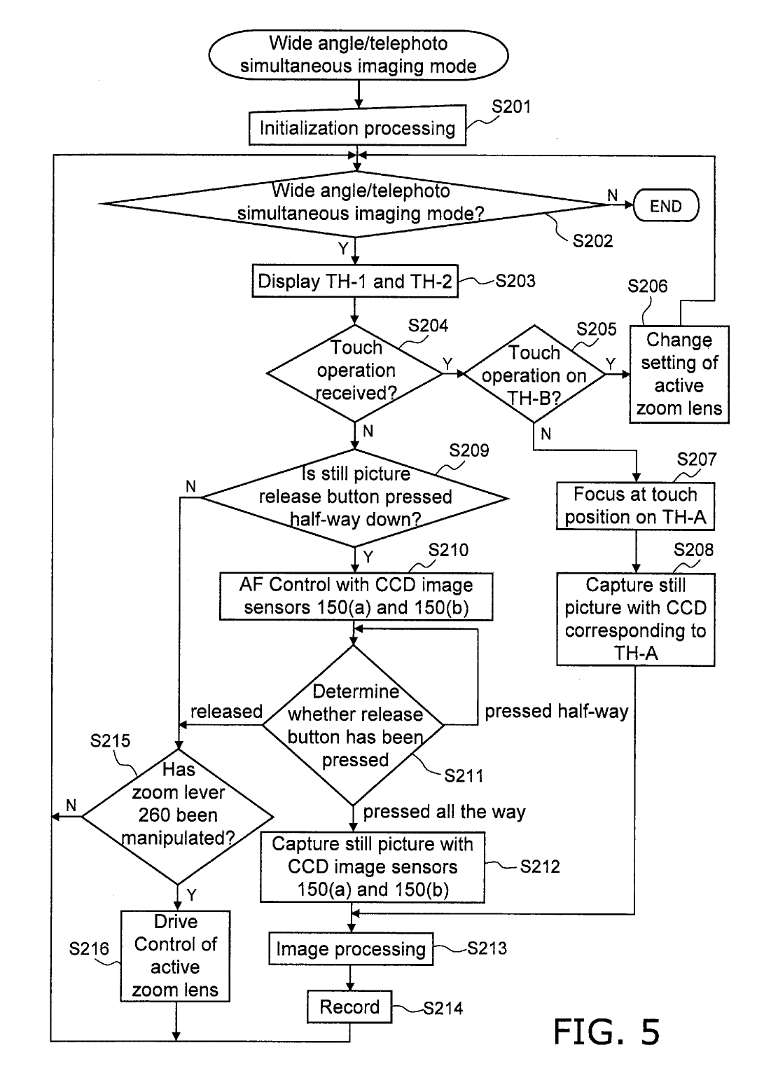

The imaging operation of the digital camera 1 in wide angle/telephoto simultaneous imaging mode will now be described. FIG. 5 is a flowchart illustrating the imaging operation of the digital camera 1 in wide angle/telephoto simultaneous imaging mode.

The controller 210 executes initialization processing for wide angle/telephoto simultaneous imaging mode in response to a switch to the wide angle/telephoto simultaneous imaging mode with the mode setting switch 290 (S201). More specifically, the controller 210 sets either the zoom lens 111(a) or the zoom lens 111(b) to be the active zoom lens, as one type of initialization processing.

Next, the controller 210 determines whether or not the mode setting switch 290 indicates the wide angle/telephoto simultaneous imaging mode (S202). If the mode setting switch 290 is indicating the wide angle/telephoto simultaneous imaging mode, the processing proceeds to step S203. If the mode setting switch 290 is not indicating the wide angle/telephoto simultaneous imaging mode, the processing ends.

Next, the controller 210 displays the first through image TH1 and the first through image TH1 on the liquid crystal display 270 (S203). Here, as shown in FIG. 4, the controller 210 displays the active through image TH-A corresponding to the active zoom lens, larger than the inactive through image TH-B that does not correspond to the active zoom lens.

Next, the controller 210 determines whether or not the touch panel 275 has received touch operation from the user (S204).

If it is determined in step S204 that the touch panel 275 has received touch operation, the controller 210 determines whether or not the touch operation is on the inactive through image TH-B (S205).

If it is determined in step S205 that the touch operation is on the inactive through image TH-B, the controller 210 executes a change in the setting of the active zoom lens (S206). Here, as shown in FIG. 5, the controller 210 also changes the active through image TH-A corresponding to the active zoom lens.

If it is determined in step S205 that the touch operation is not on the inactive through image TH-B, that is, if the touch operation is made on the active through image TH-A, then the controller 210 focuses at the touch position on the active through image TH-A (S207).

Next, the controller 210 captures a still picture with either the CCD image sensor 150(a) or 150(b), depending on which one corresponds to the active through image TH-A (S208). After this, the processing proceeds to step S213.

Also, if it is determined in step S204 that the touch panel 275 has not received touch operation, the controller 210 determines whether or not the still picture release button has been pressed half-way down (S209).

If it is determined in step S209 that the still picture release button has been pressed half-way down, the controller 210 executes AF control for the CCD image sensors 150(a) and 150(b) (S210).

Next, the controller 210 determines the pressing state of the still picture release button of the manipulation members 250 (S211). If it is determined in step S211 that the half-way pressing has been released, the processing proceeds to step S215. If it is determined in step S211 that the half-way pressing is being maintained, the determination of step S211 is repeated. If it is determined in step S211 that the button has been pressed all the way down, the processing proceeds to step S212.

If it is determined in step S211 that the button has been pressed all the way down, the controller 210 captures still pictures with the CCD image sensors 150(a) and 150(b) (S212).

Next, the controller 210 performs various kinds of image processing according to the wide angle/telephoto simultaneous imaging mode on the first and second image data produced in step S208 or S212 (S213).

Next, the controller 210 records to the memory card 240 the first and second image data that has undergone the various image processing in S213 (S214).

Also, if it is determined in step S209 that the still picture release button has not been pressed half-way down, or if it is determined in step S211 that the half-way pressing has been released, the controller 210 determines whether or not zoom manipulation of the zoom lever 260 has been received from the user (S215).

If it is determined in step S215 that zoom manipulation of the zoom lever 260 has been received, the controller 210 execute drive control of the active zoom lens according to this zoom manipulation (S216).

After the processing of step S216, or if it is determined in step S215 that there has been no zoom manipulation of the zoom lever 260, the processing returns to step S202.

1-4. Conclusion

The digital camera 1 pertaining to this embodiment comprises the zoom lever 260 that receives zoom manipulation for driving one of the zoom lenses 111(a) and 111(b), the touch panel 275 that receives selection manipulation (one example of “a particular input”) for selecting either the zoom lens 111(a) or 111(b) as the active zoom lens that will be the object of zoom manipulation, and the zoom controller 212 that controls the drive of the active zoom lens according to the zoom manipulation.

Therefore, even though only one zoom lever 260 is provided, it is easy to tell whether the zoom lens 111(a) or 111(b) is the object of zoom manipulation on the basis of the selection manipulation received by the touch panel 275.

The digital camera 1 pertaining to this embodiment also comprises the display controller 213 that displays the active through image TH-A larger than the inactive through image TH-B on the liquid crystal display 270.

Thus, the display of the active through image TH-A can be distinguished from that of the inactive through image TH-B in the first through image TH1 and the second through image TH2. Accordingly, the user can easily ascertain whether the zoom lens 111(a) or 111(b) has been driven by zoom manipulation of the zoom lever 260. Also, since the active through image TH-A is displayed larger, the user can easily confirm on the liquid crystal display 270 that AF control of the active through image TH-A has been properly executed.

### Other Embodiments

Although not touched upon in the embodiment above, the controller 210 may execute what is known as “tracking focus,” according to the touch operation on the active through image TH-A. More specifically, upon completion of focusing at the touch position of the CCD image sensor corresponding to the active through image TH-A, the controller 210 may continue AF control until the capture of a moving or still picture corresponding to the active through image TH-A is complete.

Also, in the above embodiment, the user was able to distinguish between the active through image TH-A and the inactive through image TH-B in the first through image TH1 and the second through image TH2 because the active through image TH-A was displayed larger than the inactive through image TH-B, but this is not the only option. For example, a box may be drawn around the active through image TH-A, or guidelines indicating the horizontal and vertical directions may be displayed within the active through image TH-A, so that the user can distinguish between the active through image TH-A and the inactive through image TH-B. The active through image TH-A may also be designated by including an arrow or a text display.

Also, in the above embodiment, the first through image TH1 and the second through image TH2 were displayed side by side on the left and right on the liquid crystal display 270, but this is not the only option. The first through image TH1 and the second through image TH2 may be displayed one above the other, or may be displayed on alternating lines, on the liquid crystal display 270.

With the digital camera 1 in the above embodiment, the various blocks may be individually made into chips by using an integrated circuit or other such semiconductor device, or chips may be made that include all or some of these blocks.

Also, the various processing in the above embodiment may be accomplished by hardware or by software. Furthermore, the processing may consist of a mixture of hardware and software. If the digital camera 1 pertaining to the above embodiment is realized by hardware, it should go without saying that the timing will need to be adjusted to perform the various processing. In the above embodiment, details about timing adjustment of the various signals produced in an actual hardware design are omitted for the sake of simplifying the description.

The order in which the processing method is executed in the above embodiment is not necessarily limited to what was given in the above embodiment, and the execution order can be varied without departing from the gist of the invention.

The specific constitution of the present invention is not limited to or by the above embodiment, and various changes and modifications are possible without departing from the gist of the invention.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Accordingly, these terms, as utilized to describe the present invention should be interpreted with respect to the compound-eye imaging device.

The term “configured” as used herein to describe a component, section, or part of a device includes hardware and/or software that is constructed and/or programmed to carry out the desired function.

The terms of degree such as “substantially” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicants, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A compound-eye imaging device comprising:
a first optical system having a first zoom lens configured to operate as an active zoom lens;
a second optical system having a second zoom lens configured to operate as an active zoom lens;
a first imaging sensor configured to capture a subject image formed by the first optical system and output first image data;
a second imaging sensor configured to capture a subject image formed by the second optical system and output second image data;
a zoom manipulation component configured to be manipulated to drive either the first zoom lens or the second zoom lens;
an interface configured to receive a particular input to select either the first zoom lens as the active zoom lens or the second zoom lens as the active zoom lens, the particular input being the object of manipulation of the zoom manipulation component; and
a zoom controller configured to drive the active zoom lens according to how the zoom manipulation component is manipulated.

2. The compound-eye imaging device according to claim 1, further comprising:
a display device configured to display a first through image that corresponds to the first image data and a second through image that corresponds to the second image data, the first through image and the second through image being displayed side by side; and
a display controller configured to control how the display device displays the first through image and the second through image, the being induced to display an active through image that corresponds to the active zoom lens and an inactive through image that does not correspond to the active zoom lens.

3. The compound-eye imaging device according to claim 2, wherein
the display controller is configured to control the display device to display the active through image so that the active through image is larger than the inactive through image.

4. The compound-eye imaging device according to claim 2, wherein
the interface is a touch panel disposed on the display device and configured to receive the particular input via a touch operation, and
the zoom controller is configured to set either the first zoom lens as the active zoom lens or the second zoom lens as the active zoom lens, whichever one corresponds to the inactive through image, when the interface has received the touch operation on the inactive through image.

5. The compound-eye imaging device according to claim 4, further comprising:
an AF controller configured to execute a focusing operation at the position where contact occurred on the active through image when the interface has received a touch operation on the active through image.

6. The compound-eye imaging device according to claim 5, wherein
after executing the focusing operation on the position where contact occurred on the interface, the AF controller is configured to maintain focus on the position until a moving picture is captured that corresponds to the active through image or a still picture is captured that corresponds to the active through image.
